(19) United States
(12) Patent Application Publication
(10) Pub. No.: US 2025/0380789 A1
(43) Pub. Date: Dec. 18, 2025

(54) HYBRID COSMETIC PACKAGING DEVICE

(71) Applicant: JIANGMEN C.H. PLASTIC FACTORY LTD., Jiangmen, Guangdong (CN)

(72) Inventor: Zhencheng Ou, Jiangmen, Guangdong (CN)

(21) Appl. No.: 18/875,186

(22) PCT Filed: Aug. 8, 2022
(86) PCT No.: PCT/CN2022/110737

§ 371 Date: Dec. 16, 2024

(30) Foreign Application Priority Data
Jun. 14, 2022 (CN) 202210668546.9

(51) Int. Cl. A45D 40/24; A45D 44/00; A45D 44/02; B01F 23/41; B01F 27/07; B01F 27/1125; B01F 27/90; B01F 33/501; B01F 35/75; B01F 101/21

(52) U.S. Cl. CPC A45D 40/24; A45D 44/02; B01F 23/41; B01F 27/071; B01F 27/11253; B01F 27/90; B01F 33/5011; B01F 35/753; B01F 35/75445; A45D 2044/007; A45D 2200/058; B01F 2101/21

(57) ABSTRACT

The present disclosure relates to the technical field of packaging, and discloses a hybrid cosmetics packaging device comprising a housing, and a mixing mechanism, a discharge mechanism, storage bottles and a PLC arranged within the housing, wherein the mixing mechanism comprises a mixing chamber, a stirring assembly and supplying assemblies, the supplying assembly conveys base materials in the storage bottles to the mixing chamber, and the discharge assembly conveys a cosmetic product in the mixing chamber to a product outlet. The housing is provided with a skin detector which measures a water-to-oil ratio of skin and feeds back same to the PLC, and the PLC outputs a signal to the supplying assemblies to adjust discharge amount of base materials discharged from the storage bottles. In the present disclosure, the proportion of each base material can be adjusted in a personalized mode according to the skin state of a user.

### TECHNICAL FIELD

The present disclosure relates to the technical field of packaging, and specifically to a hybrid cosmetics packaging device.

### BACKGROUND

With the improvement of the quality of life, people's requirements for maintaining and caring for their own skin are gradually increasing. In different regions and different climate environments, people's skin has different dryness, humidity, and oil secretion, which will directly render that users have different feelings about the effects of skincare products. Besides, existing skincare product packaging devices usually only store a single skincare product. When the users use a variety of different skincare products in accordance with their current skin conditions, a variety of different skin care products needs to be mixed. However, this requires the use of multiple bottles of skincare products, which is inconvenient to store and cumbersome to operate.

### SUMMARY OF THE DISCLOSURE

An objective of the present disclosure is to provide a hybrid cosmetics packaging device which is capable of personalizing proportions of various base materials according to a user's skin condition to achieve the best skincare effect and is recycled.

In order to achieve the objective, the present disclosure provides a hybrid cosmetic packaging device, comprising a housing and a mixing mechanism, a discharge mechanism, a plurality of storage bottles and a programmable logic controller (PLC), which are arranged inside the housing, wherein the storage bottles are provided to store different cosmetic base materials, the mixing mechanism comprises a mixing chamber, a stirring assembly and a plurality of supplying assemblies, the stirring assembly is mounted to the mixing chamber, the supplying assemblies are in one-to-one correspondence with the storage bottles and convey the cosmetic base materials in the respective storage bottles to the mixing chamber, and the discharge mechanism is connected with the mixing chamber and conveys a cosmetic product in the mixing chamber to a product outlet provided on the mixing chamber; and a skin detector is provided at an outer wall of the housing or at a bottom of the housing for detecting a water-to-oil ratio of skin of a user, the PLC is electrically connected with the mixing mechanism, the discharge mechanism, and the skin detector respectively, the skin detector detects the water-to-oil ratio of the skin of the user in real time and outputs a signal to the PLC, and the PLC is in wireless communication connection with a mobile terminal and outputs the signal to the supplying assemblies to adjust discharge amounts of the respective storage bottles.

In a preferred embodiment of the present disclosure, the product outlet is provided on a top surface of the mixing chamber, the discharge mechanism comprises a discharge drive and a pusher, an outer circumference of the pusher is tightly pressed against an inner side wall of the mixing chamber, the top surface of the mixing chamber is in a downward concave arc shape, a top surface of the pusher is matched in shape with the top surface of the mixing chamber, the discharge drive is fixed to the housing, and an output end of the discharge drive is connected to the pusher for driving the pusher to move up and down in the mixing chamber.

In a preferred embodiment of the present disclosure, a movable channel is provided inside the pusher, the stirring assembly comprises a stirring drive, a push drive and a movable stirring paddle, the push drive is fixed to the housing, the movable stirring paddle comprises a movable rod and a stowable blade component, the movable rod is provided with an accommodating groove component for accommodating the stowable blade component, an output end of the stirring drive is connected to the movable rod for driving the movable rod to rotate, an output end of the push drive is connected to the stirring drive for moving the movable stirring paddle move up and down in the movable channel; and after the stowable blade component is accommodated in the accommodating groove component, an outer wall of the stowable blade component is flush with an outer wall of the movable rod.

In a preferred embodiment of the present disclosure, the stowable blade component comprises a plurality of silicone stirring blades that are tilted upwards.

In a preferred embodiment of the present disclosure, the stowable blade component comprises a plurality of stirring blades that are tilted upwards, and a bottom of each of the stirring blades is connected to the movable rod through a torsion spring.

In a preferred embodiment of the present disclosure, each of the storage bottles comprises a base, an inner sleeve, an upper sleeve, a spiral sleeve and a movable plate, the inner sleeve is fixed to the base, the upper sleeve is rotatably fitted on the inner sleeve, the spiral sleeve is fixed to an inner wall of the upper sleeve, the inner sleeve is provided with a vertical lifting groove that coordinates with the movable plate, and the spiral sleeve is provided with a spiral groove that coordinates with the movable plate to move the movable plate up and down inside the inner sleeve;
each of the supplying assemblies comprises a supplying drive and a connecting sleeve, an output end of the supplying drive is connected to the connecting sleeve for driving the connecting sleeve to rotate, the connecting sleeve is provided with a locating chamber that is in plug fit with the upper sleeve, the locating chamber is provided with a locating groove, and an outer wall of the upper sleeve is provided with a locating protrusion that coordinates with the locating groove; and
the base is detachably connected to the housing through a fixing assembly.

In a preferred embodiment of the present disclosure, the pusher comprises a silicone discharge plate and a mounting holder connected to an underside of the silicone discharge plate, the output end of the discharge drive is connected to the mounting holder, the silicone discharge plate is provided with a first channel, the mounting holder is provided with a second channel, the first channel and the second channel are communicated to form the movable channel, and a top of the movable rod is provided with a sealing plug for blocking the product outlet.

In a preferred embodiment of the present disclosure, the base is provided with a locating recess, the fixing assembly comprises a locating pillar, a fixed plate, a guide block, a return spring and a button, the fixed plate is fixed to the housing, the guide block is connected to an underside of the fixed plate, the guide block is provided with a limiting groove that is in sliding fit with the locating pillar, the locating pillar is provided with a guide groove tilted towards the base from bottom to top, the button comprises a vertical pressing portion and a pushing portion that coordinates with the guide groove, and the return spring is connected between the fixed plate and a top of the pushing portion; and when the pressing portion of the button is pressed, the top of the pushing portion is pushed close to the fixed plate and the return spring is compressed, so that the pushing portion drives the locating pillar away from the locating recess until the locating pillar completely disengages from the locating recess; and when the pressing portion of the button is released, the pushing portion moves the top of the pushing portion away from the fixed plate under an action of the return spring and drives the locating pillar to press against the locating recess.

In a preferred embodiment of the present disclosure, a supplying channel is connected between the inner sleeve and the mixing chamber, and a blocking assembly is provided inside the housing, the blocking assembly comprises a blocking drive, a first blocking gear and a second blocking gear engaging with the first blocking gear, the blocking drive is mounted to the housing, an output end of the blocking drive is connected to the first blocking gear for driving the first blocking gear to rotate, the first blocking gear is provided with a first eccentric through-hole that communicates an outlet of the inner sleeve and an inlet of the supplying channel, and the second blocking gear is provided with a second eccentric through-hole that communicates an inlet of the mixing chamber and an outlet of the supplying channel.

In a preferred embodiment of the present disclosure, a bottom of the housing is provided with a bottom cover which is rotationally connected to the housing through a pivot shaft, the skin detector is mounted to the bottom cover, and the bottom cover is connected to the housing by a snap.

The hybrid cosmetic packaging device in the embodiment of the present disclosure has the following beneficial effects compared with the prior art.

In the present disclosure, the skin detector is used to detect the skin condition of a user in real time and feed information about the skin condition to the PLC, the mobile terminal is used to view the current detected skin condition and adjust and determine proportions of cosmetic base materials. Besides, the mobile terminal feeds back data information set by the user to the PLC, and the PLC outputs a signal to the supplying assemblies to adjust the discharge amounts of the respective storage bottles, thereby achieving personalized automatic allocation of cosmetic base materials (skincare products). Then, the mixing mechanism mixes and emulsifies the various cosmetic base materials, and finally, the discharge mechanism transports the finished cosmetic product to the product outlet for use by the user. It can be seen that the present disclosure is able to carry out personalized allocation of cosmetic base materials in accordance with the skin condition of a user, which satisfies personalized needs of the user and achieve the optimal skincare effect.

### BRIEF DESCRIPTION OF THE DRAWINGS

In order to more clearly illustrate the technical solutions of the present disclosure, the following description will briefly introduce the accompanying drawings that need to be used in the description of embodiments of the present disclosure.

FIG. 1 is a schematic structure diagram of a hybrid cosmetic packaging device according to an embodiment of the present disclosure;

FIG. 2 is a schematic structure diagram of a hybrid cosmetic packaging device in a stirring state according to an embodiment of the present disclosure;

FIG. 3 is a schematic structure diagram of a hybrid cosmetic packaging device in an extrusion state according to an embodiment of the present disclosure;

FIG. 4 is a schematic structure diagram of a fixing assembly in a locked state according to an embodiment of the present disclosure;

FIG. 5 is a schematic structure diagram of a fixing assembly in an unlocked state according to an embodiment of the present disclosure;

FIG. 6 is a schematic structure diagram of a stowable paddle component according to an embodiment of the present disclosure; and

FIG. 7 is a schematic structure diagram of a bottom cover according to an embodiment of the present disclosure.

Reference signs: housing 1, bottom cover 11, top cover 12, storage bottle 2, base 21, upper sleeve 22, locating recess 211, mixing chamber 3, product outlet 31, supplying drive 32, connecting sleeve 33, supplying channel 34, first blocking gear 35, second blocking gear 36, blocking drive 37, pusher 4, silicone discharge plate 41, mounting holder, 42, movable stirring paddle 5, movable rod 51, push part 511, accommodating groove 52, silicone stirring blade 53, locating pillar 61, guide groove 611, fixed plate 62, guide block 63, limiting groove 631, return spring 64, button 65, pressing portion 651, pushing portion 652, skin detector 7, and PLC 8.

### DETAILED DESCRIPTION

The implementations of the present disclosure will be further described in detail with reference to the accompanying drawings and embodiments. The following embodiments are used to illustrate the present disclosure, but not to limit the scope of the present disclosure.

In the description of the present disclosure, it is to be understood that the terms “above”, “below”, “inside”, “outside”, “top”, “bottom”, etc., indicate an orientation or positional relationship based on that shown in the accompanying drawings, and they are intended solely for the purpose of facilitating the description of the present disclosure and simplifying the description, and do not indicate or imply an involved device or component to must have a particular orientation, or to be constructed and operated in a particular orientation. Therefore, the terms are not to be construed as a limitation of the present disclosure. It is to be understood that the term “first”, “second”, or the like, is used to describe various types of elements, however, the element should not be limited to these terms and these terms are only used to distinguish a same type of elements. For example, without departing from the scope of the present disclosure, the “first” element may also be referred as the “second” element, and similarly, the “second” element may also be referred as the “first” element.

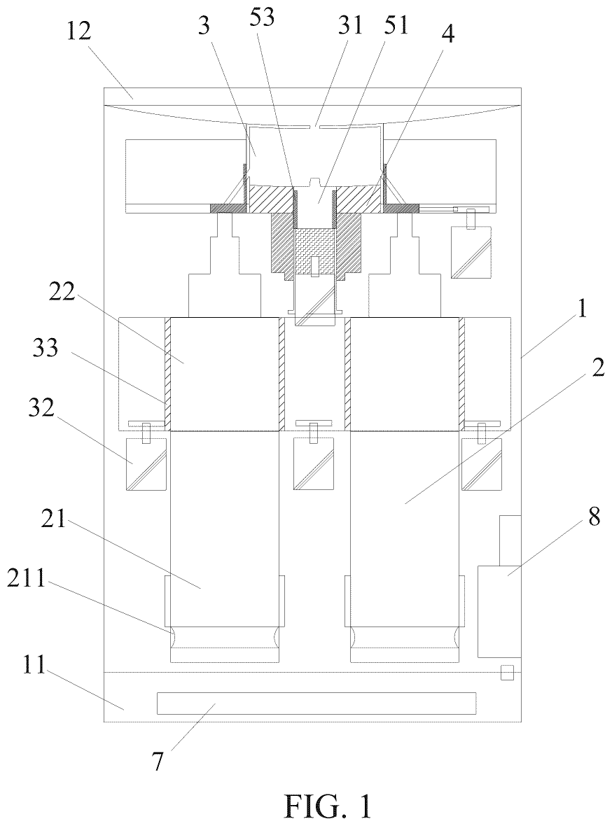

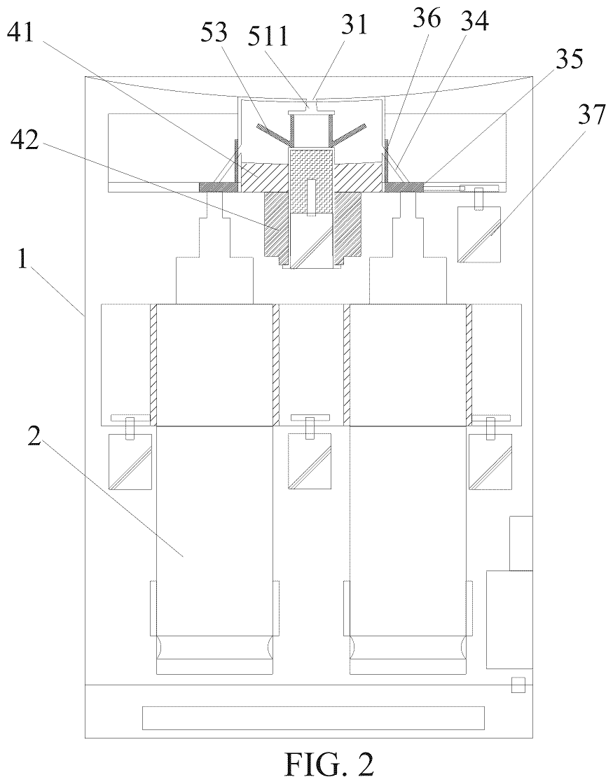

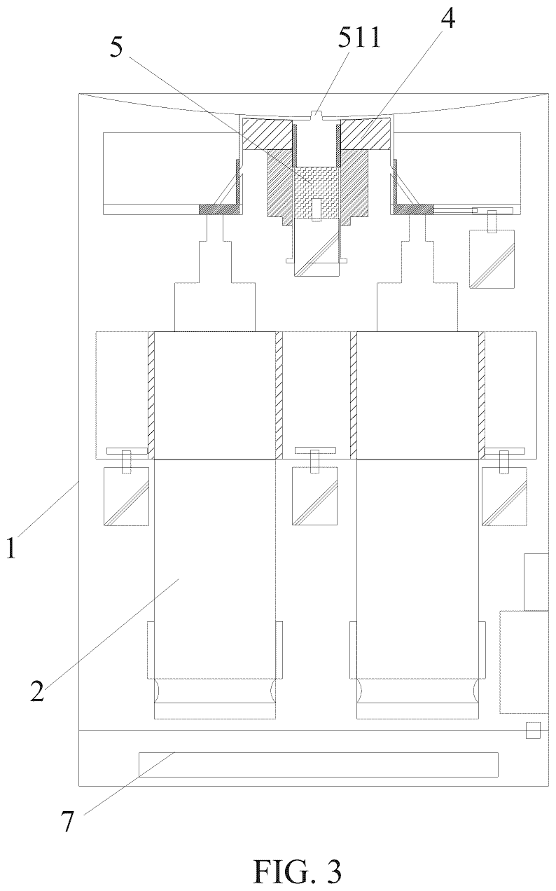

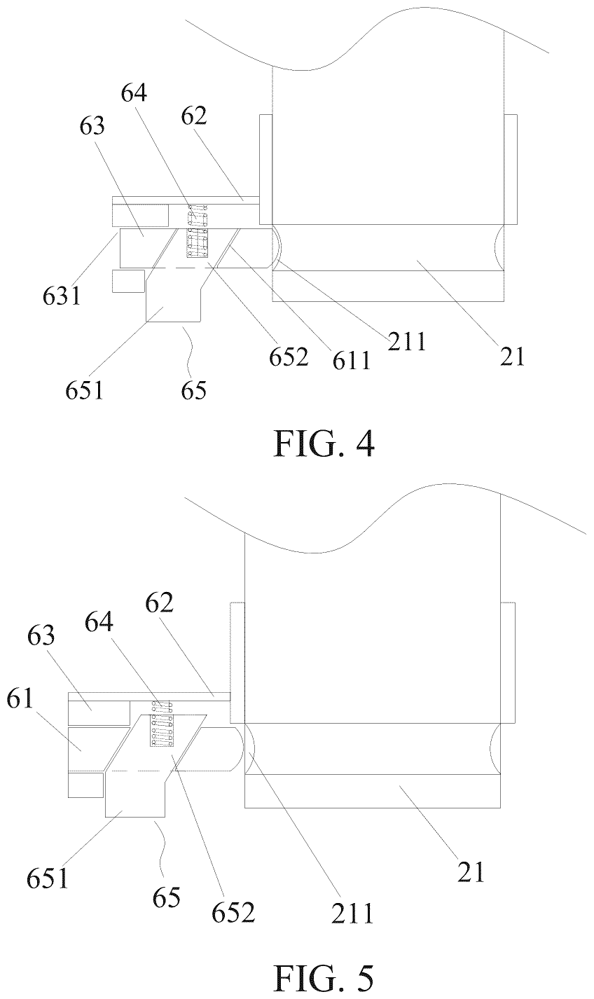

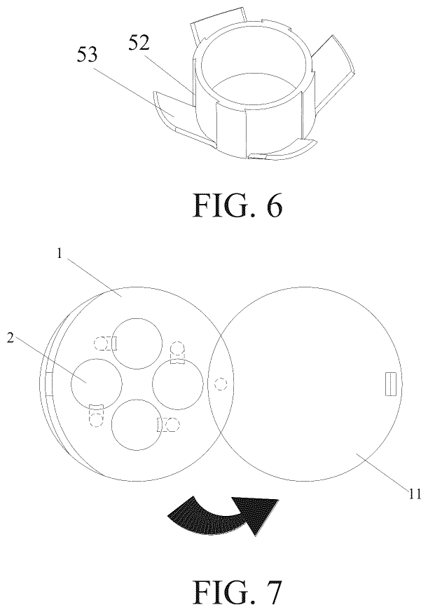

Referring FIG. 1 to FIG. 7, a hybrid cosmetic packaging device is provided in a preferred embodiment of the present disclosure. The hybrid cosmetic packaging device comprises a housing 1, and a mixing mechanism, a discharge mechanism, a plurality of storage bottles 2 and a PLC 8, which are arranged inside the housing 1. The storage bottles 2 are provided to store different cosmetic base materials. The mixing mechanism comprises a mixing chamber 3, a stirring assembly and a plurality of supplying assemblies. The stirring assembly is mounted to the mixing chamber 3. The supplying assemblies are in one-to-one correspondence with the storage bottles 2 and convey the cosmetic base materials in the respective storage bottles 2 to the mixing chamber 3. The discharge mechanism is connected with the mixing chamber 3 and conveys a cosmetic product in the mixing chamber 3 to a product outlet 31 provided on the mixing chamber 3. A skin detector 7 is provided at an outer wall of the housing 1 or at a bottom of the housing 1 for detecting a water-to-oil ratio of skin of a user. The PLC 8 is electrically connected with the mixing mechanism, the discharge mechanism, and the skin detector 7, respectively. The skin detector 7 detects the water-to-oil ratio of the skin of the user in real time and outputs a signal to the PLC 8. The PLC 8 is in wireless communication connection with a mobile terminal and outputs the signal to the supplying assemblies to adjust discharge amounts of the respective storage bottles 2. A battery is provided inside the housing 1 for supplying power to various components. Preferably, the mobile terminal may be a cell phone, a laptop, a tablet computer, etc. The wireless connection may be achieved by a cellular network (e.g., 2G, 3G, 4G, 5G), a wireless sensor network (e.g., Bluetooth, ZigBee), a wireless network (e.g., a wireless local area network WLAN), or the like. The storage bottles 2 are used for storing cosmetic base materials, which may be different base materials, such as a moisturizing base material, an oil control base material, a wrinkle resistant base material, a whitening base material. A cosmetic base material allocation database corresponding to human skin parameters is preset on the mobile terminal.

In this embodiment, the mobile terminal is a smartphone, and the hybrid cosmetic packaging device is wirelessly connected to the smartphone through Bluetooth. The smartphone is installed with an APP which has a cosmetic base material allocation database corresponding to human skin parameters. When the skin detector 7 scans the user's skin and feeds back skin data to the APP of the smartphone, the user can obtain all the parameters of his/her current skin condition, and select a product formulation in the cosmetic base material allocation database of the APP for mixing and using.

In this way, the skin detector 7 can detect the skin condition of the user in real time and feedback the skin condition to the PLC 8. The current detected skin condition can be viewed through the mobile terminal, and at the same time, the proportions of cosmetic base materials can be adjusted and determined on the mobile terminal. The mobile terminal feeds back data set by the user to the PLC 8, and the PLC 8 outputs a signal to the supplying assemblies to adjust discharge amounts of the respective storage bottles 2, thereby achieving personalized automatic allocation of cosmetic base materials (skincare products). Then, the mixing mechanism mixes and emulsifies the cosmetic base materials, and finally, the discharge mechanism transports the finished cosmetic product to the product outlet 31 for use. It can be seen that the present disclosure is able to carry out personalized allocation of cosmetic base materials, which satisfies personalized needs of the user and achieve the optimal skincare effect.

In an example, the product outlet 31 is provided on a top surface of the mixing chamber 3, the discharge mechanism comprises a discharge drive and a pusher 4, an outer circumference of the pusher 4 is tightly pressed against an inner side wall of the mixing chamber 3, the top surface of the mixing chamber 3 is in a downward concave arc shape, a top surface of the pusher 4 is matched in shape with the top surface of the mixing chamber 3, the discharge drive is fixed to the housing 1, and an output end of the discharge drive is connected to the pusher 4 for driving the pusher 4 to move up and down in the mixing chamber 3. The discharge drive is an electric push rod, or a combination of a motor and a gear rack pair, and in a case of a gear rack pair, the rack of the gear rack pair is connected to the pusher 4. The pusher 4 enables the finished cosmetic product obtained after mixing and emulsification to be completely extruded out of the product outlet 31, so that there is no residual cosmetic product in the mixing chamber 3, thereby avoiding the influence of residual cosmetic product on the proportions of the respective cosmetic base materials during next use, and effectively ensuring high accuracy of the proportions of the respective cosmetic base materials in each use. It is to be noted that when the extrusion is not carried out, the pusher 4 is located at the lowest position in the mixing chamber 3.

In an example, a movable channel is provided inside the pusher 4, the stirring assembly comprises a stirring drive, a push drive and a movable stirring paddle 5, the push drive is fixed to the housing 1, the movable stirring paddle 5 comprises a movable rod 51 and a stowable blade component, the movable rod 51 is provided with an accommodating groove component 52 for accommodating the stowable blade component, an output end of the stirring drive is connected to the movable rod 51 for driving the movable rod 51 to rotate, and an output end of the push drive is connected to the stirring drive for moving the movable stirring paddle 5 up and down in the movable channel; and after the stowable blade component is accommodated in the accommodating groove component 52, an outer wall of the stowable blade component is flush with an outer wall of the movable rod 51. The stirring drive is preferably a motor, the push drive may be an electric pushrod or a combination of a motor and a gear rack pair. In this way, when the cosmetic base materials are subjected to mixing and emulsification after they are supplied into the mixing chamber 3, the push drive drives the movable stirring paddle 5 to move upwards so that the stowable blade component of the movable stirring paddle 5 leaves the movable channel and enters the mixing chamber 3. When the movable stirring paddle 5 carries out the stirring, a top of the movable stirring paddle 5 seals the product outlet 31 to prevent the cosmetic base materials from splashing out during the stirring, thereby ensuring good stability and reliability of the overall operation. When the mixing and emulsification operation is completed, the push drive drives the movable stirring paddle 5 to move downwards so that the entire movable stirring paddle 5 is withdrawn in the movable channel and the stowable blade component is accommodated in the accommodating groove component 52. For extrusion, the movable stirring paddle 5 and the pusher 4 move upwards simultaneously to extrude the cosmetic product in the mixing chamber 3.

In the example, the stowable blade component comprises a plurality of silicone stirring blades 53 that are tilted upwards. Silicone is resistant to compression deformation and has a wide hardness range, so that when the entire movable stirring paddle 5 is withdrawn in the movable channel, the silicone stirring blades 53 are driven to be accommodated in the accommodating groove component 52, and at the same time, the cosmetic product adhered to the silicone stirring blades 53 are extruded into the mixing chamber 3, which ensures that the cosmetic product in the mixing chamber 3 can be completely extruded out of the product outlet 31 when the cosmetic product is extruded and there is no residue cosmetic product in the mixing chamber 3, thereby avoid influence on the accuracy of the proportions of the respective cosmetic base materials in next use.

In another example, the stowable blade component comprises a plurality of stirring blades that are tilted upwards, and a bottom of each of the stirring blades is connected to the movable rod 51 through a torsion spring, so that when the entire movable stirring paddle 5 is withdrawn in the movable channel, the stirring blades are driven to be accommodated in the accommodating groove component 52, and after the movable stirring paddle 5 leaves the movable channel, the stirring blades unfold under an reset action of the torsion spring.

In an example, each of the storage bottles 2 comprises a base 21, an inner sleeve, an upper sleeve 22, a spiral sleeve and a movable plate, the inner sleeve is fixed to the base 21, the upper sleeve 22 is rotatably fitted on the inner sleeve, the spiral sleeve is fixed to an inner wall of the upper sleeve 22, the inner sleeve is provided with a vertical lifting groove that coordinates with the movable plate, and the spiral sleeve is provided with a spiral groove that coordinates with the movable plate to move the movable plate up and down inside the inner sleeve. Each of the storage bottles 2 has a structure similar to the structure of a knob type lipstick shell, and its structure and working principle refers to Chinese patent No. CN200920061251.5.

Each of the supplying assemblies comprises a supplying drive 32 and a connecting sleeve 33, an output end of the supplying drive 32 is connected to the connecting sleeve 33 for driving the connecting sleeve 33 to rotate, the connecting sleeve 33 is provided with a locating chamber that is in plug fit with the upper sleeve 22, the locating chamber is provided with a locating groove, and an outer wall of the upper sleeve 22 is provided with a locating protrusion that coordinates with the locating groove. Preferably, the locating chamber is provided with a plurality of locating grooves, in order to facilitate the locating protrusion of the upper sleeve 22 to be inserted into a locating groove for circumferential limiting. In this way, the supplying drive 32 is a motor, a gear connected to an output end of the motor and a mating gear provided on the outer surface of the connecting sleeve 33, so that the connecting sleeve 33 is driven to rotate and the upper sleeve 22 is rotated synchronously, which in turn moves the movable plate upwards to move the cosmetic base material, and then the cosmetic base material is extruded out of the outlet of each of the storage bottles 2 to the mixing chamber 3. The base 21 is detachably connected to the housing 1 through a fixing assembly. Such a design achieves a removable replacement design for each of the storage bottles 2. When the cosmetic base material in one of the storage bottles 2 is run out by the user, the one of the storage bottles 2 can be replaced separately, which realizes that the main body of the hybrid cosmetic packaging device can be recycled repeatedly. Each of the storage bottles 2 is prepared from a biodegradable material, which is in line with the concept of green and environmental protection.

In an example, the pusher 4 comprises a silicone discharge plate 41 and a mounting holder 42 connected to an underside of the silicone discharge plate 41, the output end of the discharge drive is connected to the mounting holder 42, the silicone discharge plate 41 is provided with a first channel, the mounting holder 42 is provided with a second channel, and the first channel and the second channel are communicated to form the movable channel. The mounting holder 42 effectively supports the silicone discharge plate 41. A top of the movable rod 51 is provided with a push part 511 that coordinates with the product outlet 31, which ensures that the cosmetic product is completely extruded out of the product outlet 31.

In an example, the base 21 is provided with a locating recess 211, and the fixing assembly comprises a locating pillar 61, a fixed plate 62, a guide block 63, a return spring 64 and a button 65. The fixed plate 62 is fixed to the housing 1, the guide block 63 is connected to an underside of the fixed plate 62, and the guide block 63 is provided with a limiting groove 631 that is in sliding fit with the locating pillar 61. The locating pillar 61 is provided with a guide groove 611 tilted towards the base 21 from bottom to top. The button 65 comprises a vertical pressing portion 651 and a pushing portion 652 that coordinates with the guide groove 611, the pushing portion 652 is inserted into the guide groove 611, and the return spring 64 is connected between the fixed plate 62 and a top of the pushing portion 652. When the pressing portion 651 of the button 65 is pressed, the top of the pushing portion 652 is pushed close to the fixed plate 62 and the return spring 64 is compressed, so that the pushing portion 652 drives the locating pillar 61 away from the locating recess 211 until the locating pillar 61 completely disengages from the locating recess 211; and when the pressing portion 652 of the button 65 is released, the pushing portion 652 moves the top of the pushing portion 652 away from the fixed plate 62 under an action of the return spring 64 and drives the locating pillar 61 to press against the locating recess 211. The fixing assembly realizes the positioning of each of the storage bottles 2 and avoids the rotation of the base 21. After pressing the pushing portion 651 of the button 65, each of the storage bottles 2 can be removed from the connecting sleeve 33, achieving quick disassembly and assembly of each of the storage bottles 2. Preferably, the housing 1 is provided with a guide hole that matches the shape of the base 21.

In an example, a supplying channel 34 is connected between the inner sleeve and the mixing chamber 3, and a blocking assembly is provided inside the housing 1. The blocking assembly comprises a blocking drive 37, a first blocking gear 35 and a second blocking gear 36 engaging with the first blocking gear 35. The blocking drive 37 is mounted to the housing 1, an output end of the blocking drive 37 is connected to the first blocking gear 35 for driving the first blocking gear 35 to rotate, the first blocking gear 35 is provided with a first eccentric through-hole that communicates an outlet of the inner sleeve and an inlet of the supplying channel 34, and the second blocking gear 36 is provided with a second eccentric through-hole that communicates an inlet of the mixing chamber 3 and an outlet of the supplying channel 34. In this way, the mixed cosmetic base materials in the mixing chamber 3 are prevented from flowing back to the storage bottles 2 though the supplying channels 34 and contaminating the cosmetic bases in the storage bottles 2, and high mixing precision is ensured.

In an example, a bottom of the housing 1 is provided with a bottom cover 11 which is rotationally connected to the housing 1 through a pivot shaft, and the skin detector 7 is mounted to the bottom cover 11. The bottom cover 11 is connected to the housing by a snap, which is convenient for the user to open the bottom cover 11 to carry out a replacement operation of each of the storage bottles 2. Besides, the product outlet 31 is provided at the top of the housing 1, and the skin detector 7 is provided at the bottom cover 11 of the housing 1, which is convenient for use. In addition, the top of the housing 1 is provided with a top cover 12 to prevent the product outlet 31 from external contamination.

In the description of the present disclosure, it is to be noted that, unless otherwise specified and limited, the terms “connection” and “connecting” are to be broadly understood, for example, they can comprise a fixed connection, a detachable connection, or an integral connection; a mechanical connection, or an electrical connection; a direct connection, or an indirect connection through an intermediate medium; or an internal connection within two elements. For those skilled in the art, the specific meanings of the above terms in the present disclosure can be understood in specific cases.

The above-described embodiments are only preferred embodiments of the present disclosure. It should be pointed out that, for those skilled in the art, several improvements and substitutions can be made without departing from the technical principles of the present disclosure, and these improvements and substitutions should also fall within the scope of protection of the present disclosure.

1. A hybrid cosmetic packaging device, comprising a housing and a mixing mechanism, a discharge mechanism, a plurality of storage bottles and a PLC, which are arranged inside the housing, wherein the storage bottles are provided to store different cosmetic base materials;
the mixing mechanism comprises a mixing chamber, a stirring assembly and a plurality of supplying assemblies, the stirring assembly is mounted to the mixing chamber, the supplying assemblies are in one-to-one correspondence with the storage bottles and convey the cosmetic base materials in the respective storage bottles to the mixing chamber, and the discharge mechanism is connected with the mixing chamber and conveys a cosmetic product in the mixing chamber to a product outlet provided on the mixing chamber; and
a skin detector is provided at an outer wall of the housing or at a bottom of the housing for detecting a water-to-oil ratio of skin of a user, the PLC is electrically connected with the mixing mechanism, the discharge mechanism, and the skin detector respectively, the skin detector detects the water-to-oil ratio of the skin of the user in real time and outputs a signal to the PLC, and the PLC is in wireless communication connection with a mobile terminal and outputs the signal to the supplying assemblies to adjust discharge amounts of the respective storage bottles.

2. The hybrid cosmetic packaging device according to claim 1, wherein the product outlet is provided on a top surface of the mixing chamber; and
the discharge mechanism comprises a discharge drive and a pusher, an outer circumference of the pusher is tightly pressed against an inner side wall of the mixing chamber, the top surface of the mixing chamber is in a downward concave arc shape, a top surface of the pusher is matched in shape with the top surface of the mixing chamber, the discharge drive is fixed to the housing, and an output end of the discharge drive is connected to the pusher for driving the pusher to move up and down in the mixing chamber.

3. The hybrid cosmetic packaging device according to claim 2, wherein a movable channel is provided inside the pusher;
the stirring assembly comprises a stirring drive, a push drive and a movable stirring paddle, and the push drive is fixed to the housing;
the movable stirring paddle comprises a movable rod and a stowable blade component, the movable rod is provided with an accommodating groove component for accommodating the stowable blade component, an output end of the stirring drive is connected to the movable rod for driving the movable rod to rotate, and an output end of the push drive is connected to the stirring drive for moving the movable stirring paddle move up and down in the movable channel; and
after the stowable blade component is accommodated in the accommodating groove component, an outer wall of the stowable blade component is flush with an outer wall of the movable rod.

4. The hybrid cosmetic packaging device according claim 3, wherein the stowable blade component comprises a plurality of silicone stirring blades that are tilted upwards.

5. The hybrid cosmetic packaging device according to claim 3, wherein the stowable blade component comprises a plurality of stirring blades that are tilted upwards, and a bottom of each of the stirring blades is connected to the movable rod through a torsion spring.

6. The hybrid cosmetic packaging device according to claim 3, wherein each of the storage bottles comprises a base, an inner sleeve, an upper sleeve, a spiral sleeve and a movable plate, the inner sleeve is fixed to the base, the upper sleeve is rotatably fitted on the inner sleeve, the spiral sleeve is fixed to an inner wall of the upper sleeve, the inner sleeve is provided with a vertical lifting groove that coordinates with the movable plate, and the spiral sleeve is provided with a spiral groove that coordinates with the movable plate to move the movable plate up and down inside the inner sleeve;
each of the supplying assemblies comprises a supplying drive and a connecting sleeve, an output end of the supplying drive is connected to the connecting sleeve for driving the connecting sleeve to rotate, the connecting sleeve is provided with a locating chamber that is in plug fit with the upper sleeve, the locating chamber is provided with a locating groove, and an outer wall of the upper sleeve is provided with a locating protrusion that coordinates with the locating groove; and
the base is detachably connected to the housing through a fixing assembly.

7. The hybrid cosmetic packaging device according to claim 3, wherein the pusher comprises a silicone discharge plate and a mounting holder connected to an underside of the silicone discharge plate, the output end of the discharge drive is connected to the mounting holder, the silicone discharge plate is provided with a first channel, the mounting holder is provided with a second channel, the first channel and the second channel are communicated to form the movable channel, and a top of the movable rod is provided with a sealing plug for blocking the product outlet.

8. The hybrid cosmetic packaging device according claim 6, wherein the base is provided with a locating recess;
the fixing assembly comprises a locating pillar, a fixed plate, a guide block, a return spring and a button, the fixed plate is fixed to the housing, the guide block is connected to an underside of the fixed plate, the guide block is provided with a limiting groove that is in sliding fit with the locating pillar, the locating pillar is provided with a guide groove tilted towards the base from bottom to top, the button comprises a vertical pressing portion and a pushing portion that coordinates with the guide groove, and the return spring is connected between the fixed plate and a top of the pushing portion; and
when the pressing portion of the button is pressed, the top of the pushing portion is pushed close to the fixed plate and the return spring is compressed, so that the pushing portion drives the locating pillar away from the locating recess until the locating pillar completely disengages from the locating recess; and when the pressing portion of the button is released, the pushing portion moves the top of the pushing portion away from the fixed plate under an action of the return spring and drives the locating pillar to press against the locating recess.

9. The hybrid cosmetic packaging device according to claim 6, wherein a supplying channel is connected between the inner sleeve and the mixing chamber, and a blocking assembly is provided inside the housing;
the blocking assembly comprises a blocking drive, a first blocking gear and a second blocking gear engaging with the first blocking gear, the blocking drive is mounted to the housing, an output end of the blocking drive is connected to the first blocking gear for driving the first blocking gear to rotate, the first blocking gear is provided with a first eccentric through-hole that communicates an outlet of the inner sleeve and an inlet of the supplying channel, and the second blocking gear is provided with a second eccentric through-hole that communicates an inlet of the mixing chamber and an outlet of the supplying channel.

10. The hybrid cosmetic packaging device according to claim 1, wherein a bottom of the housing is provided with a bottom cover which is rotationally connected to the housing through a pivot shaft, the skin detector is mounted to the bottom cover, and the bottom cover is connected to the housing by a snap.
